(19) United States
(12) Patent Application Publication
(10) Pub. No.: US 2014/0134419 A1
(43) Pub. Date: May 15, 2014

(54) LIQUID CRYSTALLINE POLYMER COMPOSITION FOR MELT-EXTRUDED SHEETS

(71) Applicant: Ticona LLC, Florence, KY (US)

(72) Inventors: Young Shin Kim, Erlanger, KY (US); Xinyu Zhao, Cincinnati, OH (US)

(73) Assignee: Ticona LLC, Florence, KY (US)

(21) Appl. No.: 14/032,287

(22) Filed: Sep. 20, 2013

Related U.S. Application Data
(60) Provisional application No. 61/724,351, filed on Nov. 9, 2012.
(60) Provisional application No. 61/778,875, filed on Mar. 13, 2013.

(51) Int. Cl. C08L 67/04; B29C 51/10

(52) U.S. Cl. CPC C08L 67/04; B29C 51/10
USPC 428/220; 525/437; 264/571; 264/175

(57) ABSTRACT

A melt-extruded sheet form thermoforming applications is provided. The sheet is formed from a polymer composition containing one or more thermotropic liquid crystalline polymers. The specific nature of the polymer or blend of polymers is selectively controlled so that the resulting polymer composition possesses both a low viscosity and high melt strength.

### RELATED APPLICATIONS

The present application claims priority to U.S. Provisional Application Ser. Nos. 61/724,351 (filed on Nov. 9, 2012) and 61/778,875 (filed on Mar. 13, 2013), which are incorporated herein in their entirety by reference thereto

### BACKGROUND OF THE INVENTION

Many baked goods, such as rolls, cookies, pizzas, etc., are baked on cookware or bakeware. The bakeware can be flat, such as a baking sheet, or can be shaped, such as bakeware containing domed portions or cavities. Conventional cookware and bakeware articles have been made from metals. For example, aluminum, copper, cast iron and stainless steel have all been used to produce the above described articles. Unfortunately, food stuffs have a tendency to stick to metal surfaces. To remedy this problem, modern metal cooking pans and baking pans are frequently coated with a substance that minimizes the possibility of food sticking to the surface of the utensil. Coatings that have been used in the past include, for instance, polytetrafluoroethylene (PTFE) or silicone. Although these coatings can deliver non-stick properties, they have a tendency to break down, peel off and degrade over time requiring either replacement or periodic recoating of the metal cookware and bakeware. In addition, metal bakeware also tends to be relatively heavy and can corrode. Metal bakeware can also produce loud and noisy sounds when handled. In the past, the use of non-metallic materials has been investigated for cookware and bakeware articles. For example, wholly aromatic polyester resins have been tried that inherently possess good anti-stick properties. To thermoform sheets from such polymers, a relatively high melt strength is generally required. Unfortunately, it is often difficult to obtain wholly aromatic polyester resins with the requisite degree of melt strength without sacrificing other important thermal or mechanical properties.

As such, a need currently exists for an improved liquid crystalline polymer composition that can be more readily formed into melt-extruded sheets for thermoforming applications.

### SUMMARY OF THE INVENTION

In accordance with one embodiment of the present invention, a melt-extruded sheet is disclosed that has a thickness of about 0.5 millimeters or more. The sheet comprises a polymer composition that includes a thermotropic liquid crystalline polymer. The polymer composition has a melt viscosity of from about 35 to about 500 Pa-s (determined in accordance with ISO Test No. 11443 at 15° C. higher than the melting temperature of the composition and at a shear rate of 400 seconds⁻¹), a maximum engineering stress of from about 340 kPa to about 600 kPa (determined at the melting temperature of the composition with an extensional viscosity fixture and a rotational rheometer), and a melting temperature of from about 300° C. to about 400° C.

In accordance with another embodiment of the present invention, a method for forming a sheet having a thickness of about 0.5 millimeters or more is disclosed. The method comprises extruding a polymer composition, such as described above, to produce a precursor sheet, and thereafter, calendaring the precursor sheet to form the sheet.

In accordance with yet another embodiment of the present invention, a polymer composition is disclosed that comprises a first liquid crystalline polymer in an amount from about 10 wt. % to about 90 wt. % of the polymer content of the composition and a second liquid crystalline polymer in an amount from about 10 M.% to about 90 wt. % of the polymer content of the composition. The polymer composition has a melt viscosity of from about 35 to about 500 Pa-s, as determined in accordance with ISO Test No. 11443 at 15° C. higher than the melting temperature of the composition and at a shear rate of 400 seconds⁻¹. The composition also exhibits a maximum engineering stress of from about 340 kPa to about 600 kPa, as determined at the melting temperature of the composition with an extensional viscosity fixture and a rotational rheometer. Further, the melting temperature of the composition is from about 300° C. to about 400° C.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a plan view of one embodiment of a cookware tray made in accordance with one embodiment of the present invention;

FIG. 2 is a side view of the cookware tray illustrated in FIG. 1;

FIG. 3 is an alternative embodiment of a cookware tray made in accordance with one embodiment of the present invention;

FIG. 4 is a side view of a process for forming extruded polymeric sheets in accordance with one embodiment of the present invention;

FIG. 5 is a side view of a thermoforming process that may be employed in one embodiment of the present invention;

FIG. 6 is a graph depicting the engineering stress versus strain for the samples in the Example; and

FIG. 7 is a graph depicting the elongational viscosity versus strain for the samples in the Example.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a melt-extruded sheet that can be readily thermoformed into a shaped, three-dimensional article. The sheet has a thickness of about 0.5 millimeters or more, in some embodiments from about 0.6 to about 20 millimeters, and in some embodiments, from about 1 to about 10 millimeters. The sheet is formed from a polymer composition containing one or more thermotropic liquid crystalline polymers. The specific nature of the polymer or blend of polymers is selectively controlled so that the resulting polymer composition possesses both a low viscosity and high melt strength. The present inventor has discovered that this unique combination of thermal properties results in a composition that is both highly melt processable and stretchable, which allows the resulting sheet to be more readily formed into thermoformed articles without sacrificing the desired thermal and/or mechanical properties.

The polymer composition may, for example, have a melt viscosity of from about 35 to about 500 Pa-s, in some embodiments from about 35 to about 250 Pa-s, in some embodiments from about 40 to about 200 Pa-s, and in some embodiments, from about 50 to about 100 Pa-s, determined at a shear rate of 400 seconds⁻¹. The polymer composition may also have a melt viscosity of from about 25 to about 150 Pa-s, in some embodiments from about 30 to about 125 Pa-s, and in some embodiments, from about 35 to about 100 Pa-s, determined at a shear rate of 1000 seconds⁻¹. Melt viscosity may be determined in accordance with ISO Test No. 11443 at 15° C. higher than the melting temperature of the composition. The polymer composition may also have a complex viscosity of about 5,000 Pa-s or less, in some embodiments about 2,500 Pa-s or less, and in some embodiments, from about 400 to about 1,500 Pa-s at angular frequencies ranging from 0.1 to 500 radians per second (e.g., 0.1 radians per second). The complex viscosity may be determined by a parallel plate rheometer at 15° C. above the melting temperature and at a constant strain amplitude of 1%.

The melt strength of the polymer composition can be characterized by the engineering stress and/or viscosity at a certain percent strain and at the melting temperature of the composition. As explained in more detail below, such testing may be performed in accordance with the ARES-EVF during which an extensional viscosity fixture (“EVF”) is used on a rotational rheometer to allow the measurement of the material stress versus percent strain. In this regard, the present inventor has discovered that the polymer composition can have a relatively high maximum engineering stress even at relatively high percent strains. For example, the composition can exhibit its maximum engineering stress at a percent strain of from about 0.3% to about 1.5%, in some embodiments from about 0.4% to about 1.5%, and in some embodiments, from about 0.6% to about 1.2%. The maximum engineering stress may, for instance, range from about 340 kPa to about 600 kPa, in some embodiments from about 350 kPa to about 500 kPa, and in some embodiments, from about 370 kPa to about 420 kPa. Just as an example, at a percent strain of about 0.6%, the composition can exhibit a relatively high engineering stress of 340 kPa to about 600 kPa, in some embodiments from about 350 kPa to about 500 kPa, and in some embodiments, from about 360 kPa to about 400 kPa. The elongational viscosity may also range from about 350 kPa-s to about 1500 kPa-s, in some embodiments from about 500 kPa-s to about 1000 kPa-s, and in some embodiments, from about 600 kPa-s to about 900 kPa-s. Without intending to be limited by theory, the ability to achieve enhanced such an increased melt strength can allow the resulting sheet to better maintain its shape during thermoforming without exhibiting a substantial amount of sag.

The composition can also have a relatively high storage modulus. The storage modulus of the composition, for instance, may be from about 1 to about 250 Pa, in some embodiments from about 2 to about 200 Pa, and in some embodiments, from about 5 to about 100 Pa, as determined at the melting temperature of the composition (e.g., about 360° C.) and at an angular frequency of 0.1 radians per second. The composition may also have a relatively high melting temperature. For example, the melting temperature of the polymer may be from about 300° C. to about 400° C., in some embodiments from about 320° C. to about 395° C., and in some embodiments, from about 340° C. to about 380° C.

Various embodiments of the present invention will now be described in further detail.

### I. Polymer Composition

As indicated above, the composition contains a thermotropic liquid crystalline polymer or blend of such polymers to achieve the desired properties. Liquid crystalline polymers are generally classified as “thermotropic” to the extent that they can possess a rod-like structure and exhibit a crystalline behavior in its molten state (e.g., thermotropic nematic state). Such polymers may be formed from one or more types of repeating units as is known in the art. Liquid crystalline polymers may, for example, contain one or more aromatic ester repeating units, typically in an amount of from about 60 mol. % to about 99.9 mol. %, in some embodiments from about 70 mol. % to about 99.5 mol. %, and in some embodiments, from about 80 mol. % to about 99 mol. % of the polymer. The aromatic ester repeating units may be generally represented by the following Formula (I):

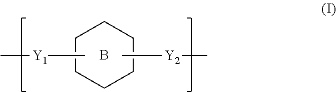

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 5 mol. % to about 60 mol. %, in some embodiments from about 10 mol. % to about 55 mol. %, and in some embodiments, from about 15 mol. % to about 50% of a polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 10 mol. % to about 85 mol. %, in some embodiments from about 20 mol. % to about 80 mol. %, and in some embodiments, from about 25 mol. % to about 75 mol. % of a polymer.

Other repeating units may also be employed. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 30 mol. %, in some embodiments from about 2 mol. % to about 25 mol. %, and in some embodiments; from about 5 mol. % to about 20 mol. % of a polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of a polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, liquid crystalline polymers may be “low naphthenic” to the extent that they contain a minimal content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) is typically no more than 30 mol. %, in some embodiments no more than about 15 mol. %, in some embodiments no more than about 10 mol. %, in some embodiments no more than about 8 mol. %, and in some embodiments, from 0 mol. % to about 5 mol. % of a polymer (e.g., 0 mol. %). Despite the absence of a high level of conventional naphthenic acids, it is believed that the resulting “low naphthenic” polymers are still capable of exhibiting good thermal and mechanical properties.

Liquid crystalline polymers may be prepared by initially introducing the aromatic monomer(s) used to form ester repeating units (e.g., aromatic hydroxycarboxylic acid, aromatic dicarboxylic acid, etc.) and/or other repeating units (e.g., aromatic dial, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 250° C. to about 400° C., in some embodiments from about 280° C. to about 395° C., and in some embodiments, from about 290° C. to about 400° C. For instance, one suitable technique for forming the liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 250° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 250° C. to about 350° C. The polymerization time will of course vary based on the temperature and target molecular weight. In most cases, however, the solid-state polymerization time will be from about 2 to about 12 hours, and in some embodiments, from about 4 to about 10 hours.

As indicated above, one or more liquid crystalline polymers may be employed to achieve the desired properties of the resulting polymer composition. In certain embodiments, the polymer composition may be formed from a blend that contains a first liquid crystalline polymer and a second liquid crystalline polymer. The first polymer may be highly flowable and more liquid-like in nature, while the second polymer may be less flowable but have a higher degree of melt strength. By carefully controlling the relative concentration of such polymers, the resulting composition may be formed with the desired properties. For example, the first liquid crystalline polymer may constitute from about 10 wt. % to about 90 wt. %, in some embodiments from about 25 wt. % to about 75 wt. %, in some embodiments from about 35 wt. % to about 65 wt. %, and in some embodiments, from about 40 wt. % to about 60 wt. % of the polymer content of the composition, while the second liquid crystalline polymer may constitute from about 10 wt. % to about 90 wt. %, in some embodiments from about 25 wt. % to about 75 wt. %, in some embodiments from about 35 wt. % to about 65 wt. %, and in some embodiments, from about 40 wt. % to about 60 wt. % of the polymer content composition.

The highly flowable first liquid crystalline polymer may have a relatively low molecular weight as reflected by its melt viscosity. That is, the first liquid crystalline polymer may have a melt viscosity of from about 1 to about 60 Pa-s, in some embodiments from about 5 to about 50 Pa-s, and in some embodiments, from about 10 to about 40 Pa-s at a shear rate of 400 seconds⁻¹. The flowable first liquid crystalline polymer can be produced by a melt polymerization process, such as described above. The second liquid crystalline polymer may have a higher molecular weight than the first polymer. For example, the second liquid crystalline polymer may have a melt viscosity have a melt viscosity of from about 100 to about 1000 Pa-s, in some embodiments from about 200 to about 800 Pa-s, and in some embodiments, from about 300 to about 400 Pa-s at a shear rate of 400 seconds⁻¹. The second polymer can, for instance, be produced by melt polymerizing monomers to form a prepolymer, which is then solid-stated polymerized to the desired molecular weight as described above.

In terms of melt strength, the first liquid crystalline polymer typically exhibits a maximum engineering stress of only from about 0.1 to about 50 kPa, in some embodiments from about 0.5 to about 40 kPa, and in some embodiments, from about 1 to about 30 kPa. Nevertheless, the stronger, second liquid crystalline polymer may exhibit a maximum engineering stress of from about 150 kPa to about 370 kPa, in some embodiments from about 250 kPa to about 360 kPa, and in some embodiments, from about 300 kPa to about 350 kPa. Surprisingly, as noted above, the present inventors have discovered that the blended composition can actually have a higher maximum engineering stress than either of the individual polymers. Although not necessarily required, the first and second liquid crystalline polymers may each have a melting temperature within a range of from about 300° C. to about 400° C., in some embodiments from about 320° C. to about 395° C., and in some embodiments, from about 340° C. to about 380° C.

The first and second liquid crystalline polymers may have the same or different monomer constituents. In certain embodiments, for example, the polymers may be formed from repeating units derived from 4-hydroxybenzoic acid (“HBA”) and terephthalic acid (“TA”) and/or isophthalic acid (“IA”), as well as various other optional constituents. The repeating units derived from 4-hydroxybenzoic acid (“HBA”) may constitute from about 10 mol. % to about 80 mol. %, in some embodiments from about 30 mol. % to about 75 mol. %, and in some embodiments, from about 45 mol. % to about 70 mol. % of the polymer. The repeating units derived from terephthalic acid (“TA”) and/or isophthalic acid (“IA”) may likewise constitute from about 5 mol. % to about 40 mol. %, in some embodiments from about 10 mol. % to about 35 mol. %, and in some embodiments, from about 15 mol. % to about 35 mol. % of the polymer. Repeating units may also be employed that are derived from 4,4′-biphenol (“BP”) and/or hydroquinone (“HQ”) in an amount from about 1 mol. % to about 30 mol. %, in some embodiments from about 2 mol. % to about 25 mol. %, and in some embodiments, from about 5 mol. % to about 20 mol. % of the polymer. Other possible repeating units may include those derived from 6-hydroxy-2-naphthoic acid (“HNA”), 2,6-naphthalenedicarboxylic acid (“NDA”), and/or acetaminophen (“APAP”). For example, repeating units derived from HNA, NDA, and/or APAP may each constitute from about 1 mol. % to about 35 mol. %, in some embodiments from about 2 mol. % to about 30 mol. %, and in some embodiments, from about 3 mol. % to about 25 mol. % when employed. While the polymers may be formed from the same or similar monomer constituents, they may have different molecular weights as noted above.

### II. Optional Additives

To maintain the desired properties, a substantial portion of the composition is generally formed from liquid crystalline polymers. That is, about 40 wt. % or more, in some embodiments from about 45 wt. % to about 99 wt. %, and in some embodiments, from about 50 wt. % to about 95 wt. % of the composition is formed by liquid crystalline polymers. Nevertheless, the composition may optionally contain one or more additives if so desired, such as flow aids, antimicrobials, pigments, antioxidants, stabilizers, surfactants, waxes, solid solvents, flame retardants, anti-drip additives, and other materials added to enhance properties and processability. When employed, the optional additive(s) typically constitute from about 0.1 wt. % to about 60 wt. %, and in some embodiments, from about 1 wt. % to about 55 wt. %, and in some embodiments, from about 5 wt. % to about 50 wt. % of the composition.

For example, a filler material may be incorporated into the polymer composition to enhance strength. Mineral fillers may, for instance, be employed in the polymer composition to help achieve the desired mechanical properties and/or appearance. Such fillers are particularly desirable when forming thermoformed articles. When employed, mineral fillers typically constitute from about 5 wt. % to about 60 wt. %, in some embodiments from about 10 wt. % to about 55 wt. %, and in some embodiments, from about 20 wt. % to about 50 wt. % of the polymer composition. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂ (Si,Al)₄O₁₀[(OH)₂, (H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂. 4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

Fibers may also be employed as a filler material to further improve the mechanical properties. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. The high strength fibers may be formed from materials that are also generally insulative in nature, such as glass, ceramics (e.g., alumina or silica), aramids (e.g., Kevlar® marketed by E.I. DuPont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof.

The volume average length of the fibers may be from about 50 to about 400 micrometers, in some embodiments from about 80 to about 250 micrometers, in some embodiments from about 100 to about 200 micrometers, and in some embodiments, from about 110 to about 180 micrometers. The fibers may also have a narrow length distribution. That is, at least about 70% by volume of the fibers, in some embodiments at least about 80% by volume of the fibers, and in some embodiments, at least about 90% by volume of the fibers have a length within the range of from about 50 to about 400 micrometers, in some embodiments from about 80 to about 250 micrometers, in some embodiments from about 100 to about 200 micrometers, and in some embodiments, from about 110 to about 180 micrometers. The fibers may also have a relatively high aspect ratio (average length divided by nominal diameter) to help improve the mechanical properties of the resulting polymer composition. For example, the fibers may have an aspect ratio of from about 2 to about 50, in some embodiments from about 4 to about 40, and in some embodiments, from about 5 to about 20 are particularly beneficial. The fibers may, for example, have a nominal diameter of about 10 to about 35 micrometers, and in some embodiments, from about 15 to about 30 micrometers. The relative amount of the fibers in the polymer composition may also be selectively controlled to help achieve the desired mechanical properties without adversely impacting other properties of the composition, such as its flowability. For example, the fibers may constitute from about 2 wt. % to about 40 wt. %, in some embodiments from about 5 wt. % to about 35 wt. %, and in some embodiments, from about 6 wt. % to about 30 wt. % of the polymer composition.

Still other additives that can be included in the composition may include, for instance, antimicrobials, pigments (e.g., carbon black), antioxidants, stabilizers, surfactants, waxes, solid solvents, and other materials added to enhance properties and processability. Lubricants, for instance, may be employed in the polymer composition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

### III. Melt Extrusion

Any of a variety of melt extrusion techniques may generally be employed to form the sheet of the present invention. Suitable melt extrusion techniques may include, for instance, tubular trapped bubble film processes, flat or tube cast film processes, slit die flat cast film processes, etc. Referring to FIG. 4, for instance, one embodiment of a melt extrusion process is shown in more detail. As illustrated, the components of the polymer composition (e.g., polymer and any optional additives) may be initially fed to an extruder 110 that heats the composition to a temperature sufficient for it to flow. In one embodiment, the polymer composition is heated to a temperature that is at the melting temperature of the polymer composition or within a range of about 20° C. above or below the melting temperature of the polymer composition. The extruder 110 produces a precursor sheet 112. Before having a chance to solidify, the precursor sheet 112 may be fed into a nip of a calendering device 114 to form a polymeric sheet have a more uniform thickness. The calendering device 114 may include, for instance, a pair of calendering rolls that form the nip. Once calendered, the resulting polymeric sheet may optionally be cut into individual sheets 118 using a cutting device 116. The sheets formed according to the process described above generally have a relatively large surface area in comparison to their thickness. As described above, for instance, the thickness of the sheets may be about 0.5 millimeters or more, in some embodiments from about 0.6 to about 20 millimeters, and in some embodiments, from about 1 to about 10 millimeters. The surface area of one side of the polymeric sheets may likewise be greater than about 900 cm², such as greater than about 2000 cm², such as greater than about 4000 cm². In one embodiment, for instance, the surface area of one side of the polymeric sheet may be from about 1000 cm² to about 6000 cm².

The tensile and flexural mechanical properties of the sheet are also good. For example, the sheet may exhibit a flexural strength of from about 20 to about 500 MPa, in some embodiments from about 40 to about 200 MPa, and in some embodiments, from about 50 to about 150 MPa; a flexural break strain of about 0.5% or more, in some embodiments from about 0.6% to about 10%, and in some embodiments, from about 0.8% to about 3.5%; and/or a flexural modulus of from about 2,000 MPa to about 20,000 MPa, in some embodiments from about 3,000 MPa to about 20,000 MPa, and in some embodiments, from about 4,000 MPa to about 15,000 MPa. The flexural properties may be determined in accordance with ISO Test No. 178 (technically equivalent to ASTM D790-98) at 23° C. The tensile strength may also be from about 20 to about 500 MPa, in some embodiments from about 50 to about 400 MPa, and in some embodiments, from about 100 to about 350 MPa; a tensile break strain of about 0.5% or more, in some embodiments from about 0.6% to about 10%, and in some embodiments, from about 0.8% to about 3.5%; and/or a tensile modulus of from about 5,000 MPa to about 20,000 MPa, in some embodiments from about 8,000 MPa to about 20,000 MPa, and in some embodiments, from about 10,000 MPa to about 15,000 MPa. The tensile properties may be determined in accordance with ISO Test No. 527 (technically equivalent to ASTM D638) at 23° C.

### IV. Thermoformed Articles

Regardless of the manner in which it is formed, the extruded sheet may be thermoformed by heating it to a certain temperature so that it becomes flowable, shaping the sheet within a mold, and then optionally trimming the shaped article to create the desired article. For example, a sheet may be clamped inside a thermoformer and heated (e.g., with infrared heaters) to a temperature of slightly above 350° C. Depending on the type of machine used, the sheet may be transferred to a forming station or the bottom heating elements may be moved for the forming tool to be able to form the sheet. The forming tool (e.g., aluminum) may be heated to about 120° C. to about 200° C. Different thermoforming techniques can be successfully used, such as vacuum forming, plug-assist vacuum forming, pressure forming, reverse draw, twin sheet thermoforming and others. Once the forming step is completed, the part can be trimmed.

Referring to FIG. 5, for example, one particular embodiment of a thermoforming process is shown in more detail. As illustrated, the polymeric sheet 118 is first fed to a heating device 120 that heats it to a temperature sufficient to cause the polymer to deform or stretch. In general, any suitable heating device may be used, such as a convection oven, electrical resistance heater, infrared heater, etc. Once heated, the polymeric sheet 118 is fed to a molding device 122 where it is molded into an article. Any of a variety of molding devices may be employed in the thermoforming process, such as a vacuum mold. Regardless, a force (e.g., suction force) is typically placed against the sheet to cause it to conform to the contours of the mold. At the contours, for instance, the draw ratio may be greater than 1:1 to about 5:1. Molding of the polymeric sheet 118 typically occurs before the sheet substantially solidifies and/or crystallizes. Thus, the properties of the polymer are not only important during production of the polymeric sheets 118, but are also important during the subsequent molding process. If the polymeric sheet 118 were to solidify and/or crystallize too quickly, the polymer may tear, rupture, blister or otherwise form defects in the final article during molding.

As described above, various different articles may be made in accordance with the present invention. Of particular advantage, three-dimensional articles may be made that have many beneficial properties. For example, the thermoformed article can have a deflection temperature under load (DTUL) of at least about 230° C., such as from about 230° C. to about 300° C. Heat deflection temperature is defined as the temperature at which a standard test bar deflects a specified distance under a load. It is typically used to determine short term heat resistance. As used herein, DTUL is determined according to ISO Test No. 75. More particularly, the melt-extruded sheet and/or polymer composition used to form the sheet may have a DTUL at 1.8 MPa of greater than about 255° C., such as greater than about 265° C. For instance, the DTUL can be from about 245° C. to about 300° C.

The resulting article may, for example, be a package, container, tray (e.g., for a food article), electrical connector, bottle, pouch, cup, tub, pail, jar, box, engine cover, aircraft part, circuit board, etc. Although any suitable three-dimensional article can be formed, the melt-extruded sheet of the present invention is particularly well suited to producing cooking articles, such as cookware and bakeware. For example, when formed in accordance with the present invention, such articles can be capable of withstanding very high temperatures, including any oven environment for food processing. The articles are also chemical resistant and exceptionally inert. The articles, for instance, may be being exposed to any one of numerous chemicals used to prepare foods and for cleaning without degrading while remaining resistant to stress cracking. In addition, the articles may also possess excellent anti-stick or release properties. Thus, when molded into a cooking article, no separate coatings may be needed to prevent the article from sticking to food items. In this manner, many bakery goods can be prepared in cookware or bakeware without having to grease the pans before baking, thus affording a more sanitary working environment. The sheet also greatly reduces or eliminates a common issue of trapped food or grease in corners of rolled metal pans as solid radius corners can be easily incorporated into cookware.

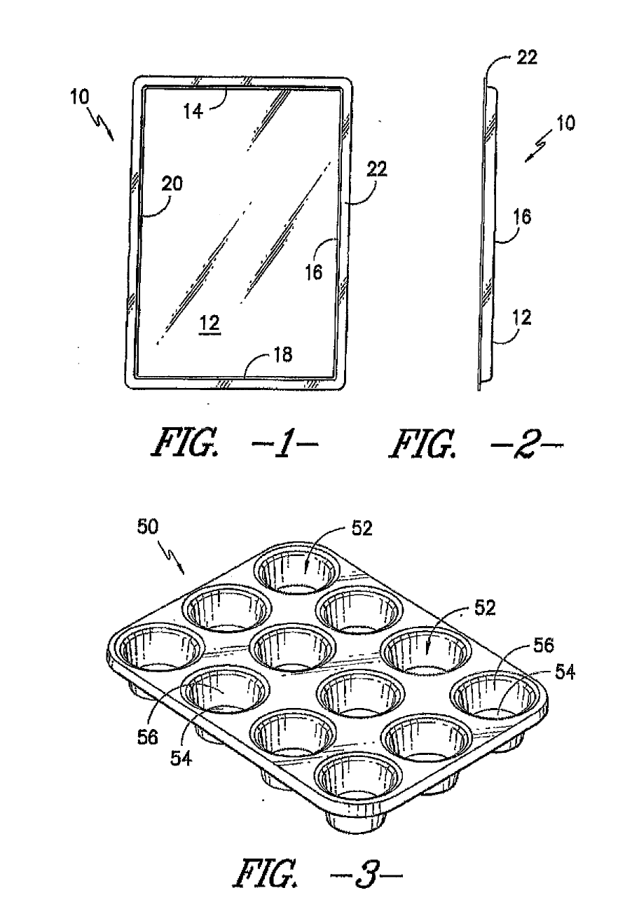

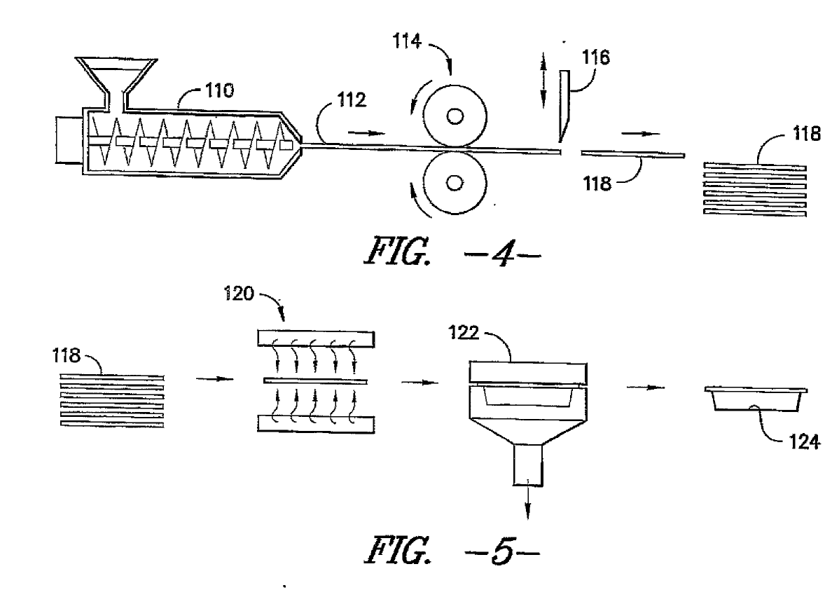

The types of cooking articles can vary dramatically depending upon the particular application. The melt-extruded sheet may, for instance, be used to produce bakeware, cookware, and any suitable parts that may be used in food processing equipment, such as cake pans, pie pans, cooking trays, bun pans, cooking pans, muffin pans, bread pans, etc. For exemplary purposes only, various different cookware articles that may be made in accordance with the present disclosure are illustrated in FIGS. 1-3. Referring to FIGS. 1-2, for instance, one embodiment of a cooking pan or tray 10 is shown that includes a bottom surface 12 that is surrounded by a plurality of walls 14, 16, 18 and 20. The bottom surface 12 is configured to receive a food item for preparation and/or serving. The side wall 16 forms a contour that transitions into the bottom surface 12. In the illustrated embodiment, the tray 10 is also surrounded by a lip or flange 22. The flange 22 may have any desired shape and/or length that assists in holding the tray during food preparation and/or when the tray is hot. An alternative embodiment of a cookware article is also shown in FIG. 3 that contains a muffin pan 50. The muffin pan 50 contains a plurality of cavities 52 for baking various food articles, such as muffins or cupcakes. As shown, each cavity 52 includes a bottom surface 54 surrounded by a circular wall 56. The muffin pan 50 can have overall dimensions similar to the cooking tray 10.

The present invention may be better understood with reference to the following example.

### Test Methods

Melt Viscosity:

The melt viscosity (Pa-s) may be determined in accordance with ISO Test No, 11443 at a shear rate of 1000 s⁻¹ and temperature 15° C. above the melting temperature (e.g., about 375° C.) using a Dynisco LCR7001 capillary rheometer. The rheometer orifice (die) had a diameter of 1 mm, length of 20 mm, LID ratio of 20.1, and an entrance angle of 180°. The diameter of the barrel was 9.55 mm+0.005 mm and the length of the rod was 233.4 mm.

Complex Viscosity:

Complex viscosity is a frequency-dependent viscosity, determined during forced harmonic oscillation of shear stress at angular frequencies of 0.1 to 500 radians per second. Prior to testing, the sample is cut into the shape of a circle (diameter of 25 mm) using a hole-punch. Measurements are determined at a temperature 15° C. above the melting temperature (e.g., about 375° C.) and at a constant strain amplitude of 1% using an ARES-G2 rheometer (TA Instruments) with a parallel plate configuration (25 mm plate diameter). The gap distance for each sample is adjusted according to the thickness of each sample.

Melting Temperature:

The melting temperature (“Tm”) was determined by differential scanning calorimetry (“DSC”) as is known in the art. The melting temperature is the differential scanning calorimetry (DSC) peak melt temperature as determined by ISO Test No. 11357. Under the DSC procedure, samples were heated and cooled at 20° C. per minute as stated in ISO Standard 10350 using DSC measurements conducted on a TA Q2000 Instrument.

Melt Elongation:

Melt elongation properties (i.e., stress, strain, and elongational viscosity) may be determined in accordance with the ARES-EVF: Option for Measuring Extensional Velocity of Polymer Melts, A. Franck, which is incorporated herein by reference. In this test, an extensional viscosity fixture (“EVF”) is used on a rotational rheometer to allow the measurement of the engineering stress at a certain percent strain. More particularly, a thin rectangular polymer melt sample is adhered to two parallel cylinders: one cylinder rotates to wind up the polymer melt and lead to continuous uniaxial deformation in the sample, and the other cylinder measures the stress from the sample. An exponential increase in the sample length occurs with a rotating cylinder. Therefore, the Hencky strain (ε_{H}) is determined as function of time by the following equation: ε_{H}(t)=ln(L(t)/Lₒ), where Lₒ is the initial gauge length of and L(t) is the gauge length as a function of time. The Hencky strain is also referred to as percent strain. Likewise, the elongational viscosity is determined by dividing the normal stress (kPa) by the elongation rate (s⁻¹). Specimens tested according to this procedure have a width of 1.27 mm, length of 30 mm, and thickness of 0.8 mm. The test may be conducted at the melting temperature (e.g., about 360° C.) and elongation rate of 2 s⁻¹.

Flexural Modulus, Flexural Stress, and Flexural Strain:

Flexural properties may be determined according to ISO Test No. 178 (technically equivalent to ASTM D790-98). This test may be performed on a 64 mm support span. Tests may be run on the center portions of uncut ISO 3167 multi-purpose bars. The testing temperature may be 23° C. and the testing speed may be 2 mm/min.

### EXAMPLE

A high molecular weight LCP and a low molecular weight LCP are employed in this Example. Both of the polymers are formed from 60.1% of 4-hydroxybenzoic acid (“HBA”), 3.5% of 2,6-hydroxynaphthoic acid (“HNA”), 18.2% of terephthalic acid (“TA”), 13.2% of 4,4′-biphenol (“BP”), and 5% of acetaminophen (“APAP”), such as described in U.S. Pat. No. 5,508,374 to Lee, et al. The high molecular weight grade is formed by solid-state polymerizing the low molecular weight polymer until the desired molecular weight (e.g., melting temperature and melt viscosity) are achieved.

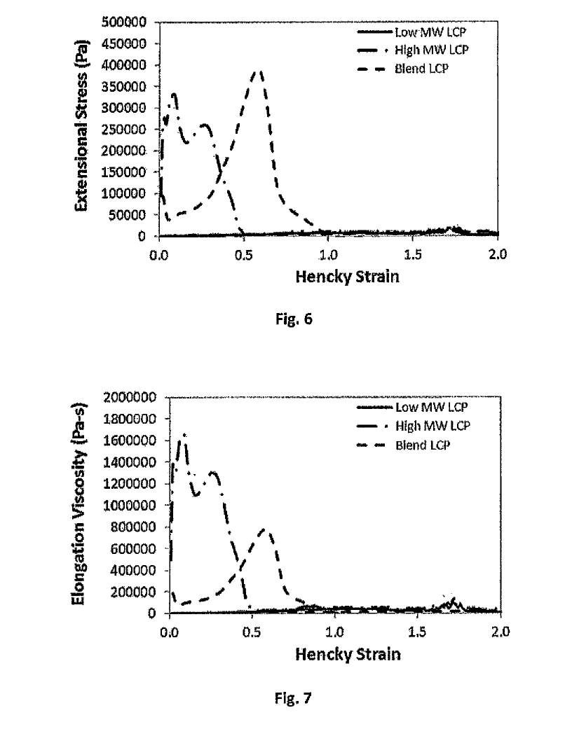

Three (3) pellet samples are formed from the LCP polymers as follows: Sample 1 (low molecular weight LCP); Sample 2 (high molecular weight LCP); and Sample 3 (blend of 50 wt. % of the low molecular weight LCP and 50 wt. % of the high molecular weight LCP). To form the samples, pellets of the liquid crystalline polymers are dried at 150° C. overnight. Thereafter, the polymers are supplied to the feed throat of a ZSK-25 WLE co-rotating, fully intermeshing twin screw extruder in which the length of the screw is 750 millimeters, the diameter of the screw is 25 millimeters, and the LID ratio is 30. The extruder has temperature zones 1-9, which may be set to the following temperatures: 330° C., 330° C., 310° C., 310° C., 310° C., 310° C., 320° C., 320° C., and 320° C., respectively. Once melt blended, the samples are extruded through a single-hole strand die, cooled through a water bath, and pelletized. The melt viscosity and melting temperature of the samples are set forth below in Table 1. The rheological properties of the polymer pellets are also set forth below in Tables 2-4. The melt elongation properties are also set forth in FIGS. 6-7.

TABLE 1
Melt Viscosity and Melting Temperature

| | Blend | High MW LCP | Low MW LCP |
|---|---|---|---|
| Melt Viscosity | 42.4 | 173.7 | 22.8 |
| (at 1000/sec, ~375° C.) (Pa-s) | | | |
| Melt Viscosity | 70.1 | 368.4 | 33.3 |
| (at 400/s, ~375° C.) (Pa-s) | | | |
| Melting Temperature (° C.) | 357 | 356 | 358 |

TABLE 2
Rheological Behavior of Low MW LCP Sample

| | | Loss | |
|---|---|---|---|
| Angular frequency | Storage modulus | modulus | Complex viscosity |
| rad/s | Pa | Pa | Pa · s |
| 0.1 | 26.9 | 48.8 | 557.1 |
| 0.2 | 46.0 | 70.7 | 532.2 |
| 0.3 | 64.9 | 103.0 | 484.8 |
| 0.4 | 85.4 | 151.1 | 436.1 |
| 0.6 | 126.8 | 197.6 | 372.1 |
| 1.0 | 156.6 | 269.7 | 311.9 |
| 1.6 | 220.2 | 375.1 | 274.4 |
| 2.5 | 316.0 | 524.6 | 243.8 |
| 4.0 | 433.5 | 699.1 | 206.6 |
| 6.3 | 622.7 | 950.5 | 180.1 |
| 10.0 | 892.3 | 1253.5 | 153.9 |
| 15.8 | 1254.2 | 1613.7 | 129.0 |
| 25.1 | 1721.3 | 2041.6 | 106.3 |
| 39.8 | 2290.5 | 2541.2 | 85.9 |
| 63.1 | 2994.3 | 3132.1 | 68.7 |
| 100.0 | 3809.4 | 3892.6 | 54.5 |
| 158.5 | 4842.2 | 4819.9 | 43.1 |
| 251.2 | 6116.7 | 6018.9 | 34.2 |
| 398.1 | 7587.8 | 7566.2 | 26.9 |
| 500.0 | 8570.5 | 8544.3 | 24.2 |

TABLE 3
Rheological Behavior of High MW LCP Sample

| | | Loss | |
|---|---|---|---|
| Angular frequency | Storage modulus | modulus | Complex viscosity |
| rad/s | Pa | Pa | Pa · s |
| 0.1 | 527.1 | 1331.3 | 14318.5 |
| 0.2 | 738.0 | 1921.6 | 12987.6 |
| 0.3 | 1025.9 | 2813.6 | 11922.6 |
| 0.4 | 1464.3 | 4151.4 | 11057.6 |
| 0.6 | 2237.2 | 6113.4 | 10317.5 |
| 1.0 | 3605.7 | 8865.6 | 9570.8 |
| 1.6 | 6011.0 | 12467.2 | 8732.8 |
| 2.5 | 9907.6 | 16674.7 | 7721.7 |
| 4.0 | 15649.0 | 20994.1 | 6577.3 |
| 6.3 | 23076.5 | 24761.9 | 5364.5 |
| 10.0 | 31740.7 | 27518.1 | 4200.9 |
| 15.8 | 40941.3 | 29113.5 | 3169.8 |
| 25.1 | 50089.8 | 29833.2 | 2321.0 |
| 39.8 | 58867.2 | 30167.9 | 1661.5 |
| 63.1 | 67307.2 | 30645.9 | 1172.1 |
| 100.0 | 75674.6 | 31670.9 | 820.3 |
| 158.5 | 84209.9 | 33514.4 | 571.9 |
| 251.2 | 93525.6 | 36287.3 | 399.4 |
| 398.1 | 103797.0 | 39789.3 | 279.2 |
| 500.0 | 109454.0 | 41872.7 | 234.4 |

TABLE 4
Rheological Behavior of Blended Sample

| | | Loss | |
|---|---|---|---|
| Angular frequency | Storage modulus | modulus | Complex viscosity |
| rad/s | Pa | Pa | Pa · s |
| 0.1 | 18.1 | 59.4 | 620.9 |
| 0.2 | 42.1 | 90.0 | 627.1 |
| 0.3 | 66.5 | 117.4 | 537.1 |
| 0.4 | 94.8 | 143.9 | 432.8 |
| 0.6 | 127.2 | 201.2 | 377.3 |
| 1.0 | 162.9 | 274.5 | 319.2 |
| 1.6 | 224.3 | 394.3 | 286.2 |
| 2.5 | 301.8 | 553.4 | 251.0 |
| 4.0 | 409.6 | 770.4 | 219.2 |
| 6.3 | 616.0 | 1070.6 | 195.8 |
| 10.0 | 909.1 | 1440.5 | 170.3 |
| 15.8 | 1321.0 | 1882.2 | 145.1 |
| 25.1 | 1856.1 | 2385.5 | 120.3 |
| 39.8 | 2540.0 | 2974.6 | 98.3 |
| 63.1 | 3351.3 | 3684.6 | 78.9 |
| 100.0 | 4313.7 | 4519.3 | 62.5 |
| 158.5 | 5479.1 | 5598.1 | 49.4 |
| 251.2 | 6954.4 | 6976.8 | 39.2 |
| 398.1 | 8643.2 | 8751.6 | 30.9 |
| 500.0 | 9673.2 | 9768.0 | 27.5 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A melt-extruded sheet that has a thickness of about 0.5 millimeters or more for use in thermoforming an article, the sheet comprising a polymer composition that includes a thermotropic liquid crystalline polymer, wherein the polymer composition has a melt viscosity of from about 35 to about 500 Pa-s, as determined in accordance with ISO Test No. 11443 at 15° C. higher than the melting temperature of the composition and at a shear rate of 400 seconds⁻¹, and wherein the composition exhibits a maximum engineering stress of from about 340 kPa to about 600 kPa, as determined at the melting temperature of the composition with an extensional viscosity fixture and a rotational rheometer, and further wherein the melting temperature of the composition is from about 300° C. to about 400° C.

2. The sheet of claim 1, wherein the polymer composition has a melt viscosity of from about 35 to about 250 Pa-s, as determined in accordance with ISO Test No. 11443 at 15° C. higher than the melting temperature of the composition and at a shear rate of 400 seconds⁻¹.

3. The sheet of claim 1, wherein the polymer composition has a complex viscosity of about 5,000 Pa-s or less at angular frequencies ranging from 0.1 to 500 radians per second, as determined by a parallel plate rheometer at 15° C. above the melting temperature and at a constant strain amplitude of 1%.

4. The sheet of claim 1, wherein the polymer composition exhibits a maximum engineering stress at a percent strain of from about 0.3% to about 1.5%, as determined at the melting temperature of the composition with an extensional viscosity fixture and a rotational rheometer.

5. The sheet of claim 1, wherein the polymer composition exhibits an elongational viscosity of from about 350 kPa-s to about 1500 kPa-s, as determined at the melting temperature of the composition with an extensional viscosity fixture and a rotational rheometer.

6. The sheet of claim 1, wherein the polymer composition exhibits a storage modulus of from about 1 to about 250 Pa as determined at the melting temperature of the composition and at an angular frequency of 0.1 rad/s.

7. The sheet of claim 1, wherein the thermotropic liquid crystalline polymer contains aromatic ester repeating units, the aromatic ester repeating units including aromatic dicarboxylic acid repeating units, aromatic hydroxycarboxylic acid repeating units, and aromatic diol repeating units.

8. The sheet of claim 7, wherein the aromatic hydroxycarboxylic acid repeating units are derived from 4-hydroxybenzoic acid, 6-hydroxy-2-naphthoic acid, or a combination thereof.

9. The sheet of claim 7, wherein the aromatic dicarboxylic acid repeating units are derived from terephthalic acid, isophthalic acid, or a combination thereof.

10. The sheet of claim 7, wherein the aromatic diol repeating units are derived from hydroquinone, 4,4′-biphenol, or a combination thereof.

11. The sheet of claim 1, wherein a first liquid crystalline polymer constitutes from about 25 wt. % to about 75 wt. % of the polymer content of the composition and the second liquid crystalline polymer constitutes from about 25 wt. % to about 75 wt. % of the polymer content of the composition.

12. The sheet of claim 11, wherein the first liquid crystalline polymer has a melt viscosity of from about 1 to about 60 Pa-s and the second liquid crystalline polymer has a melt viscosity of from about 100 to about 1000 Pa-s, as determined in accordance with ISO Test No. 11443 at 15° C. higher than the melting temperature of the composition and at a shear rate of 400 seconds⁻¹.

13. The sheet of claim 11, wherein the first liquid crystalline polymer has a maximum engineering stress of from about 0.1 to about 50 kPa and the second liquid crystalline polymer has a maximum engineering stress of from about 150 to about 370 kPa, as determined at the melting temperature of the composition with an extensional viscosity fixture and a rotational rheometer.

14. The sheet of claim 11, wherein the first liquid crystalline polymer is produced by melt polymerization and the second liquid crystalline polymer is produced by solid-state polymerization.

15. The sheet of claim 11, wherein the first liquid crystalline polymer and the second liquid crystalline polymer are formed from repeating units derived from 4-hydroxybenzoic acid in an amount from about 10 mol. % to about 80 mol. %, repeating units derived from terephthalic acid and/or isophthalic acid in an amount from about 5 mol. % to about 40 mol. %, and repeating units derived from 4,4′-biphenol and/or hydroquinone in an amount from about 1 mol. % to about 30 mol. %.

16. The sheet of claim 1, wherein the sheet has a thickness of from about 0.6 to about 20 millimeters.

17. A three-dimensional article that is shaped from the melt-extruded sheet of claim 1.

18. The three-dimensional article of claim 17, wherein the article is a cooking article.

19. A method for forming a three-dimensional article, the method comprising:
heating the melt-extruded sheet of claim 1; and
shaping the heated sheet into a three-dimensional article.

20. The method of claim 19, wherein the heated sheet is shaped with a vacuum mold.

21. A method for forming a sheet having a thickness of about 0.5 millimeters or more, the method comprising:
extruding a polymer composition to produce a precursor sheet, wherein the polymer composition includes a thermotropic liquid crystalline polymer, wherein the polymer composition has a melt viscosity of from about 35 to about 500 Pa-s, as determined in accordance with ISO Test No. 11443 at 15° C. higher than the melting temperature of the composition and at a shear rate of 400 seconds-1, and wherein the composition exhibits a maximum engineering stress of from about 340 kPa to about 600 kPa, as determined at the melting temperature of the composition with an extensional viscosity fixture and a rotational rheometer, and further wherein the melting temperature of the composition is from about 300° C. to about 400° C.; and
thereafter, calendaring the precursor sheet to form the sheet.

22. A polymer composition comprising a first liquid crystalline polymer in an amount from about 10 wt. % to about 90 wt. % of the polymer content of the composition and a second liquid crystalline polymer in an amount from about 10 wt. % to about 90 wt. % of the polymer content of the composition, wherein the polymer composition has a melt viscosity of from about 35 to about 500 Pa-s, as determined in accordance with ISO Test No. 11443 at 15° C. higher than the melting temperature of the composition and at a shear rate of 400 seconds⁻¹, and wherein the composition exhibits a maximum engineering stress of from about 340 kPa to about 600 kPa, as determined at the melting temperature of the composition with an extensional viscosity fixture and a rotational rheometer, and further wherein the melting temperature of the composition is from about 300° C. to about 400° C.

23. The polymer composition of claim 22, wherein the polymer composition has a melt viscosity of from about 35 to about 250 Pa-s, as determined in accordance with ISO Test No. 11443 at 15° C. higher than the melting temperature of the composition and at a shear rate of 400 seconds⁻¹.

24. The polymer composition of claim 22, wherein the polymer composition has a complex viscosity of about 5,000 Pa-s or less at angular frequencies ranging from 0.1 to 500 radians per second, as determined by a parallel plate rheometer at 15° C. above the melting temperature and at a constant strain amplitude of 1%.

25. The polymer composition of claim 22, wherein the polymer composition exhibits a maximum engineering stress at a percent strain of from about 0.3% to about 1.5%, as determined at the melting temperature of the composition with an extensional viscosity fixture and a rotational rheometer.

26. The polymer composition of claim 22, wherein the polymer composition exhibits an elongational viscosity of from about 350 kPa-s to about 1500 kPa-s, as determined at the melting temperature of the composition with an extensional viscosity fixture and a rotational rheometer.

27. The polymer composition of claim 22, wherein the polymer composition exhibits a storage modulus of from about 1 to about 250 Pa as determined at the melting temperature of the composition and at an angular frequency of 0.1 rad/s.

28. The polymer composition of claim 22, wherein the first liquid crystalline polymer, the second thermotropic liquid crystalline polymer, or both contain aromatic ester repeating units, the aromatic ester repeating units including aromatic dicarboxylic acid repeating units, aromatic hydroxycarboxylic acid repeating units, and aromatic diol repeating units.

29. The polymer composition of claim 28, wherein the aromatic hydroxycarboxylic acid repeating units are derived from 4-hydroxybenzoic acid, 6-hydroxy-2-naphthoic acid, or a combination thereof.

30. The polymer composition of claim 28, wherein the aromatic dicarboxylic acid repeating units are derived from terephthalic acid, isophthalic acid, or a combination thereof.

31. The polymer composition of claim 28, wherein the aromatic diol repeating units are derived from hydroquinone, 4,4′-biphenol, or a combination thereof.

32. The polymer composition of claim 22, wherein the first liquid crystalline polymer has a melt viscosity of from about 1 to about 60 Pa-s and the second liquid crystalline polymer has a melt viscosity of from about 100 to about 1000 Pa-s, as determined in accordance with ISO Test No. 11443 at 15° C. higher than the melting temperature of the composition and at a shear rate of 400 seconds⁻¹.

33. The polymer composition of claim 22, wherein the first liquid crystalline polymer has a maximum engineering stress of from about 0.1 to about 50 kPa and the second liquid crystalline polymer has a maximum engineering stress of from about 150 to about 370 kPa, as determined at the melting temperature of the composition with an extensional viscosity fixture and a rotational rheometer.

34. The polymer composition of claim 22, wherein the first liquid crystalline polymer is produced by melt polymerization and the second liquid crystalline polymer is produced by solid-state polymerization.

35. The polymer composition of claim 22, wherein the first liquid crystalline polymer and the second liquid crystalline polymer are formed from repeating units derived from 4-hydroxybenzoic acid in an amount from about 10 mol. % to about 80 mol. %, repeating units derived from terephthalic acid and/or isophthalic acid in an amount from about 5 mol. % to about 40 mol. %, and repeating units derived from 4,4′-biphenol and/or hydroquinone in an amount from about 1 mol. % to about 30 mol. %.
